(19) United States
(12) Patent Application Publication
(10) Pub. No.: US 2012/0323707 A1
(43) Pub. Date: Dec. 20, 2012

(54) Multi-Language Electronic Menu System and Method

(75) Inventor: Samantha Urban, San Francisco, CA (US)

(73) Assignee: Urban Translations, LLC., San Francisco, CA (US)

(21) Appl. No.: 13/523,870

(22) Filed: Jun. 14, 2012

Related U.S. Application Data
(60) Provisional application No. 61/496,863, filed on Jun. 14, 2011.

(51) Int. Cl. G06Q 50/12

(52) U.S. Cl. 705/15

(57) ABSTRACT

A multi-language electronic menu on a computing device receives from a user a selection of a language to be employed in displaying menu items to the user. Thereafter, the device electronically displays the menu to the user in the selected language, and allows the user to navigate amongst the menu items of the menu on the device. In doing so, the device receives selections of one or more of the items of the menu to be ordered or requested for such user, all in the selected language. The device then receives a selection from the user that the user has finished selecting menu items, and a selection that an order or request comprising a number of selected items for the users is complete, and the device sends the order or request from the device for fulfillment in a format independent of any particular language.

### CROSS-REFERENCE TO RELATED APPLICATIONS

This application claims the benefit under 35 U.S.C. §119(e) to U.S. Provisional Patent Application No. 61/496,863, filed Jun. 14, 2011, entitled, “Multi-Language Electronic Menu System and Method,” the entire disclosure of which is incorporated herein by reference.

### BACKGROUND OF THE INVENTION

1. Field of the Invention

The present disclosure relates to a system that provides and supports an electronic menu for a restaurant, hotel, airport or other terminal location, stadium, aircraft, cruise ship or other similar organization or location at which ordering of food, goods, services or other items is done through menu selection, wherein the electronic menu selection provided allows a user thereof to employ the menu in any of multiple languages. Also, the present disclosure relates to a method employed at a centralized back-end of such a system to obtain and provide translations of menu items in the multiple languages.

2. Description of Related Art

In a restaurant, hotel or other location where ordering occurs, ordering items such as food, gift or other merchandise from a menu is a relatively straight-forward matter. A typical example of a prior art ordering method in a restaurant, although by no means necessarily the only method, a wait-person hands out to a patron a pre-printed document as the menu, where the document/menu includes a number of food items or the like available for consumption at the restaurant. As should be understood, the food items of the menu may include simple items, such as for example a glass of orange juice or a side of french fries, and also complex items, such as for example a hamburger with onion rings, lettuce, tomato slice, and pickle. At any rate, the patron peruses the food items in the menu, selects one or more food items for consumption at the restaurant, and then orders the selected food items from the wait-person, usually in an oral manner. The wait-person then gives the order to a kitchen or the like in the restaurant, the kitchen prepares the order, the wait-person delivers the prepared order to the patron, and the patron then consumes the food items in the prepared order.

In a hotel, a guest may select food or other items for the room from room service from a paper or electronic menu, and then will typically call room service on the phone with his or her selection. The room service personnel then process the order and deliver the food or other items to the room. Similarly, appointments for golf tee times, items and merchandise from the gift shop or spa services in a hotel are generally provided in menu or booklet format, sometimes with television explanations or menus, and then the guest calls the appropriate telephone number for the front desk, concierge or spa facility to schedule the appointment. Gift shop merchandise or appointments can also be made in person working with hotel staff. Similar arrangements may be found on cruise ships.

In a sports or other entertainment stadium, ordering is generally done through food services located throughout the arena promenade or other restaurant area, by phone order to a restaurant or by vendor walking past the seating area.

In bus terminals, airports and other facilities, food and other items may be ordered directly at a kiosk, restaurant, or other store, or via electronic ordering menu systems provided in some locations. On airplanes, ordering may be direct through the flight attendant who may use a standard wait service approach or electronic key pad ordering system.

Generally all such ordering systems, menus, etc. are available in the native language. Notably, restaurants may find it advisable to have copies of menus for ordering food available in multiple languages. In particular, it may not be unheard of for the restaurant to have patrons that do not speak or understand the local language, particularly in more cosmopolitan areas but more generally most anywhere. Thus, if the restaurant for example is in an English-speaking area but can expect to have an appreciable number of patrons that speak and understand Portuguese, the restaurant may have copies of the menu thereof available in both English and in Portuguese.

Several problems arise, however. For one thing, the person at the restaurant that designates the food items in the menu may speak English only and not Portuguese, in which case a Portuguese translator must be engaged to provide translations of the food items from English to Portuguese for the Portuguese copy of the menu. Such an engagement may be a relatively straightforward matter if a Portuguese translator is readily available for a reasonable cost, and if the menu does not change relatively often and the services of the Portuguese translator are relatively rarely employed. However, such an engagement becomes a more complex issue when a Portuguese translator is not readily available for a reasonable cost, and/or if the menu does in fact change relatively often and the services of the Portuguese translator are more regularly employed.

For another thing, even if a Portuguese copy of the menu is prepared for the restaurant and is provided to a Portuguese-speaking patron, it is not necessarily a given that a wait-person is available who can collect an order from the Portuguese-speaking patron based on the Portuguese copy of the menu. Further, it is not necessarily a given that such a wait-person understands such a collected order, or that the wait-person or another person is available to translate the collected order from Portuguese to English or to another language that would be understood by the kitchen. Quite simply, the availability of such a Portuguese copy of such a menu has limited value if available personnel at the restaurant cannot understand and translate between English and Portuguese.

Similar problems such as those illustrated above occur in other ordering menu arrangements as well, in hotels, terminals, stadiums and similar venues where staff typically speak the native language and menu choices are available typically primarily only in the native language. Travelers and guests who do not speak the native language are put at a disadvantage when working with staff at these locations, figuring out what to order or what various items are available, the various choices associated with such items and other purchasing options.

Accordingly, a need exists for a system and a method that allow a restaurant, hotel, stadium, cruise ship, airplane, travel terminal, or similar business or location to provide a multi-language menu or ordering selection system to a patron or the like, and that allow the restaurant to receive an order from the patron in one language and to review and fulfill the order in another language. In particular, a need exists for a system and method which provides an electronic multi-language menu that allows the patron to select from among multiple languages to peruse the menu, that collects the order from the patron in the selected language, and that provides a translation of the order into another language for fulfillment. Moreover, a need exists for such a system and method that provides a centralized back-end which helps the restaurant or other business or location to construct and update the electronic multi-language menu.

### BRIEF SUMMARY OF THE INVENTION

The aforementioned needs are satisfied by a system and method performed to operate a multi-language electronic menu on a computing device. The device displays to a user, such as a patron a language selection control and receives from the patron by way of the displayed language selection control a selection of a language to be employed in displaying menu items to the patron. The language is selected from among a number of predetermined available languages. Thereafter, the device electronically displays the menu to the patron in the selected language, and allows the user, e.g., a patron, to navigate amongst the menu items of the menu on the device. In doing so, the device receives selections of one or more of the items of the menu to be ordered for such patron, all in the selected language. The device then receives a selection from the user that the user has finished selecting menu items, and a selection that an order comprising a number of selected item(s) or request(s) for the patrons is complete, and the device sends the order or request(s) from the device for fulfillment in a format independent of any particular language.

To support each device, a system and method is provided to alter the menu on each of a plurality of computing devices at an entity. A back-end server (‘back-end’) has access to the plurality of devices, grants access to an administrator of the devices for the entity, guides the administrator through altering the menu on each of the devices, and in doing so receives a text change to text of a menu item. The back-end processes the text change so that the text change occurs in each of a number of predetermined languages supported by the menu. In particular, the text change is processed with reference to a translation database which is employed to store known translations for terms in multiple languages.

The invention includes a method of operating a multi-language electronic menu on a computing device having memory within which the menu is instantiated, a processor for operating the instantiated menu in the memory, a screen for displaying a visual interface to the menu, and a selection device for selecting menu options displayed on the screen, the method comprising the device: displaying to a user a language selection control and receiving from the user by way of the displayed language selection control a selection of a language to be employed in displaying menu items to the user, the language being selected from among a number of predetermined available languages; electronically displaying the menu to the user in the selected language; allowing the user to navigate amongst the menu items of the menu on the device and receive selections of one or more of the items of the menu to be ordered or requested for such user in the selected language; receiving a selection from the user that the user has finished selecting menu items; receiving a selection that an order comprising at least one selected menu item of responding to at least one request for the user is complete; and sending the order or request from the device for fulfillment in a format independent of any particular language.

In the method, the computing device may send the order or request electronically from the device to a fulfillment area by one of a wireless local connection and a cellular telephone system connection. In one embodiment herein, the menu is a restaurant menu and the user is a patron who is a customer ordering menu items that are food items at the restaurant, and the fulfillment area may be a restaurant kitchen.

The menu may also be a menu for ordering food or other items at locations such as those selected from restaurants, hotels, cruise ships, aircraft such as passenger or private airplanes, sports or entertainment arenas, and travel terminals.

In the method, electronically displaying the menu to the user in the selected language may include displaying menu items in the selected language according to predetermined categories, the predetermined categories being displayed in the selected language.

Further, in one embodiment herein, the screen of the device is a touch-sensitive screen incorporating the selection device and wherein the user selects by touching the touch-sensitive screen at a corresponding area thereof. The menu may be hierarchically organized and displayed to the user. In addition, in the method, receiving a selection of a menu item of the menu may further comprise collecting additional information from the user regarding the ordered menu item, all according to the selected language.

In another embodiment of the method, the user is a first patron, and the method further comprises: receiving from the first patron or a second patron a selection that further ordering is required; displaying to the second patron the language selection control and receiving from the second patron by way of the displayed language selection control a selection of a second language to be employed in displaying menu items to the second patron, the second language being selected from among a number of predetermined available languages, wherein the first language is the same or different from the second language; electronically displaying the menu to the second patron in the selected second language; allowing the second patron to navigate amongst the menu items of the menu on the device and in doing so receiving selections of one or more of the items of the menu to be ordered or requested for such second patron, all in the selected second language; receiving a selection from the second patron that the second patron has finished selecting menu items; and receiving a selection that an order or request comprising at least one selected item for each of the first and the second patrons is complete.

In an additional embodiment herein, the user is a first patron, and the method further comprises: receiving from the first patron or a second patron a selection that further ordering is required; displaying to the second patron the language selection control and receiving from the second patron by way of the displayed language selection control a selection of a second language to be employed in displaying menu items to the second patron, the second language being selected from among a number of predetermined available languages, wherein the first language is the same or different from the second language, or receiving from the second patron a selection to continue in the first language; electronically displaying the menu to the second patron in the selected second language; allowing the second patron to navigate amongst the menu items of the menu on the device in the selected second language; receiving a selection from the second patron that the second patron has finished selecting menu items and that the order is complete, or that the order is complete without an additional item from the second patron.

The order may be stored in the device according to an ID for each menu item in the order, and not according to any particular language. The order may also be stored in the device according to an ID for each menu item in the order, and not according to any particular language, each menu item of the menu being stored in the memory of the device in a database, the database including for each menu item the ID thereof and a translation of the menu item in each of the predetermined available languages.

The invention also includes a method of altering a multi-language electronic menu on each of a plurality of computing devices at an entity, the method being performed at a back-end server having access to the plurality of devices and the method comprising the back-end server: granting access to an administrator of the devices for the entity; guiding the administrator through altering the menu on each of the devices, and in doing so receiving a text change to text of a menu item; and processing the text change so that the text change occurs in each of a number of predetermined languages supported by the menu, the text change being processed with reference to a translation database which is employed to store known translations for terms in multiple languages.

The back-end server is preferably remotely located from the administrator, the back-end server servicing other administrators at other entities, each of the other entities also having a multi-language electronic menu on each of a plurality of computing devices at each of the other entities.

The translation database may include for each of several terms an entry with a translation of the term in at least one language supported by the back-end server.

The translation database may also include for each of several terms an entry with a translation of the term in at least one language supported by the back-end server, wherein the translation database is initially sparsely populated with translation data such that entries in the translation database are at least partially empty, and wherein over time the translation database is filled with translation data as such data is requested and obtained.

A text change may comprise a term in a particular language supported by the menu, the term being stored in the translation database in a corresponding entry having the term and translations of the term in each of at least some languages supported by the back-end server.

The text change may also comprise a term in a particular language supported by the menu, the term being one of a word, a phrase, a clause, a sentence, or a paragraph.

Processing a text change may comprise determining from the translation database whether the text change exists as a term in an entry in such translation database; and if so determining whether the entry for the term has needed translations in the predetermined languages supported by the menu.

Processing the text change may also comprise: determining from the translation database that the text change exists as a term in an entry in such translation database; and that the entry for the term needs at least one translation in at least one of the predetermined languages supported by the menu; submitting the term for the needed translation or translations and receiving and storing same in the translation database; copying the translation for the term in at least one of the predetermined language supported by the menu from the translation database for which a translation was needed to a published master of the menu according to a master of a database associated with the menu, the master of the database being maintained at the back-end server; and copying the published master from the back-end server to each device, the copied master for being instantiated as the menu database on each device, each menu item of the menu being stored in a memory of each device in the menu database, the menu database including for each menu item a translation of the menu item in each of the predetermined languages supported by the menu.

Submitting the term may include at least one of electronically referring to an on-line database for each needed translation, electronically sending a message to a translator for each needed translation and electronically receiving the needed translation in reply, and electronically sending a message to an operator for each needed translation, after which the operator obtains the needed translation and manually supplies same.

Copying in the method preferably includes formatting the translation for the term into a format employed by the published master.

Also within the invention is a computing system employed to alter a multi-language electronic menu on each of a plurality of computing devices at an entity, the computing system having memory within which a back-end server is instantiated as a set of instructions, and a processor for operating the instantiated back-end server in the memory by executing the instructions, the computing system having access to the plurality of computing devices, wherein the instructions of the back-end server include instructions for: granting access to an administrator of the devices for the entity; guiding the administrator through altering the menu on each of the devices, and in doing so receiving a text change to text of a menu item; and processing the text change so that the text change occurs in each of a number of predetermined languages supported by the menu, the text change being processed with reference to a translation database which is employed to store known translations for terms in multiple languages.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a block diagram of an example of a computing environment within which various embodiments of the present innovation may be implemented;

FIG. 2 is a block diagram of a system including a restaurant or the like employing electronic menus on computing devices or the like in accordance with various embodiments of the present innovation;

FIG. 3 is a block diagram of one of the computing devices of FIG. 2 in accordance with various embodiments of the present innovation;

FIG. 4 is a flow diagram showing actions performed in connection with the electronic menu of the device of FIGS. 2 and 3 in accordance with various embodiments of the present innovation;

FIG. 5 is a screenshot-type view of a menu displayed on the device of FIGS. 2 and 3 in accordance with various embodiments of the present innovation;

FIG. 6 is a flow diagram showing actions performed in connection with the back-end of FIG. 2 in altering the menu of FIGS. 2, 3, and 5 in accordance with various embodiments of the present innovation; and

FIG. 7 is a block diagram of the back-end of FIG. 2 in accordance with various embodiments of the present innovation.

### DETAILED DESCRIPTION OF THE INVENTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a tip” includes a plurality of tips. Thus, for example, a reference to “a method” includes one or more methods, and/or steps of the type described herein and/or which will become apparent to those persons skilled in the art upon reading this disclosure.

For the purpose of explaining the invention in a preferred embodiment herein, a menu is being used in a restaurant having a traditional menu or point of service ordering system of some type. However the method herein can be broadly applicable to a variety of establishments aside from a traditional restaurant including other venues where a user can order food, beverages or other items, for example souvenirs, counter goods, add-on items, groceries, catering services, alcoholic drinks, and any other item wherein the person ordering elects to purchase an item from a menu of choices, which menu may vary from time-to-time and wherein the venue may benefit from a dynamic translation system in combination with point of sale or other electronic ordering. With respect to exemplary establishments, the invention is applicable to, but not limited to for example, traditional restaurants, diners, snack bars, cafeterias, mobile food truck, take-out restaurants, bars, hotels or motels with room service or choices for spa services, golf appointments for tee times, gift shop orders for gifts and merchandise and the like, travel terminals such as bus stations and airports, on aircraft such as a passenger airplane or private plane, transportation waiting areas, arenas and stadiums, movies and entertainment venues or any other areas having point of service or other menu selection available service for food, gifts, merchandise or requested services. It should also be understood that since many of such establishments provide menus on-line and also offer on-line ordering or advance ordering, such a method can be adopted for such remote ordering through a web-based platform through a lap-top, remote computer, hand-held device, iPad, PDA, smartphone and other similar platforms, wherein the user logs on to an establishment website having a dynamic and changing menu which can benefit from the translation tool herein. In such website ordering, it is contemplated that the method can be readily adapted for take-out ordering and to incorporate a request for delivery or “to-go” orders for various establishments. Similarly, it can be integrated for shipping of goods and services ordered through a menu-based system.

As used herein, “user” includes all users of the system or method herein whether the user is a patron that is someone visiting the establishment and placing an order that will be purchased by the patron; a patron who is visiting the establishment and wants to review an item, but decides not to purchase the item; a patron who orders from a menu of choices while another second patron is also using the menu and/or purchasing ordered items; a wait-person or other third party who is assisting a paying or non-paying patron in using the system or carrying out the method and similar users. It should be understood herein, that if the term “patron” is used herein, it can encompass patrons such as those noted above and any other user unless all users are expressly exempt. A “wait-person” can be any of a variety of restaurant or food service personnel that assist a user in obtaining an order using the system or method herein.

An “order” may include a traditional order of items (gifts, food, merchandise, goods) or may be a request(s) for services, such as spa services, or appointments for golf tee times. Thus use of “order” or “request” encompasses an order of items or a request for services or both unless otherwise specified.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

Example Computing Environment

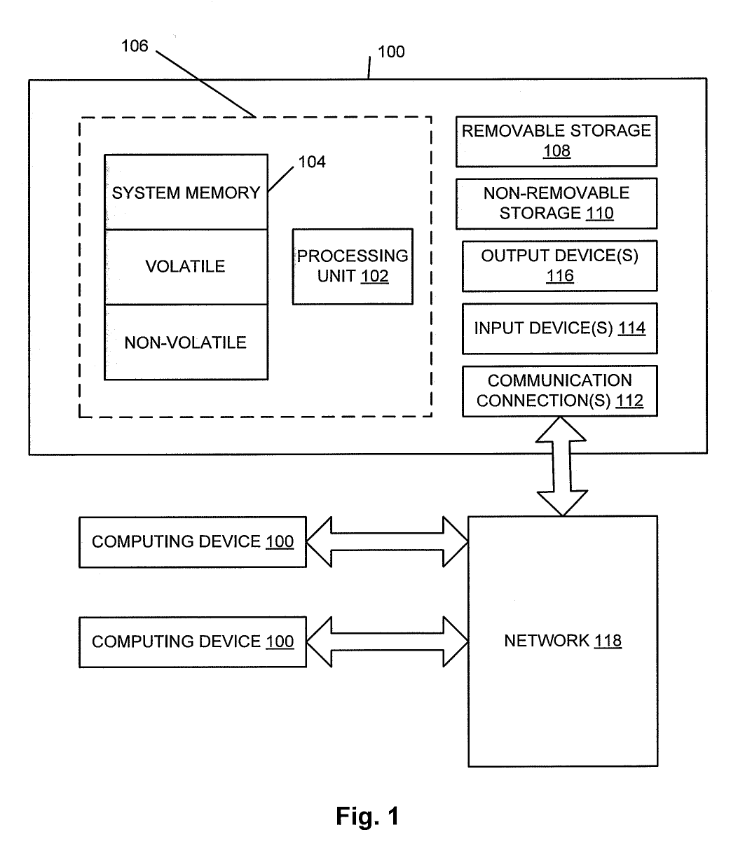

FIG. 1 is set forth herein as an exemplary computing environment in which various embodiments of the present invention may be implemented. The computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (PCs), server computers, handheld or laptop devices, multi-processor systems, microprocessor-based systems, network PCs, minicomputers, mainframe computers, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This most basic configuration is illustrated in FIG. 1 by dashed line 106. Computing device 100 may have additional features and functionality. For example, computing device 100 may include additional storage (removable and/or non-removable) including, but not limited to, magnetic or optical disks or tape. Such additional storage is illustrated in FIG. 1 by removable storage 108 and non-removable storage 110.

Computing device 100 typically includes or is provided with a variety of computer-readable hardware media. Computer-readable media can be any available media that can be accessed by computing device 100 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 104, removable storage 108, and non-removable storage 110 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other computer-readable hardware medium which can be used to store the desired information and which can accessed by computing device 100. Any such computer storage media may be part of computing device 100.

Computing device 100 may also contain communications connection(s) 112 that allow the device to communicate with other devices 100. Each such communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection (including VoIP), and wireless media such as acoustic, radio frequency (RF), infrared and other wireless media. The term computer-readable media as used herein includes both storage media and communication media.

Computing device 100 may also have input device(s) 114 such as keyboard, mouse, pen, voice input device, touch input device, etc. Output device(s) 116 such as a display, speakers, printer, etc. may also be included. All these devices are generally known to the relevant public and therefore need not be discussed in any detail herein except as provided.

Notably, computing device 100 may be one of a plurality of computing devices 100 inter-connected by a network 118, as is shown in FIG. 1. As may be appreciated, the network 118 may be any appropriate network, each computing device 100 may be connected thereto by way of a connection 112 in any appropriate manner, and each computing device 100 may communicate with one or more of the other computing devices 100 in the network 118 in any appropriate manner. For example, the network 118 may be a wired or wireless network within an organization or home or the like, and may include a direct or indirect coupling to an external network such as the Internet or the like. Likewise, the network 118 may be such an external network.

Particularly in the case where the network 118 is an external network, such network 118 may be a digitally based network (including VoIP) for exchanging computer data among the devices 100, may be an audio and/or video network for exchanging audio and/or video data among the devices 100, or the like. Thus, it may be that the network 118 may be a public switched telephone network for landline telephone communications, a mobile switching center for wireless telephone communications, a paging network for distributing paging information, a private multimedia network for establishing videoconferencing, or the like. Thus, it should be appreciated, that one or more of the computing devices 100 that are shown to the left of the network 118 in FIG. 1 may be a mobile telephone, a landline telephone, a pager, a mobile electronic mail device, a desktop electronic mail device, a mobile electronic texting device, a desktop electronic texting device, a tablet computing device, or a combination thereof.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network 118 or a distributed computing environment. Still further, aspects of the presently disclosed subject matter may be implemented in or across a plurality of processing chips or devices, and storage may similarly be effected across a plurality of devices in a network 118. Such devices might include personal computers, network servers, and handheld devices, for example.

Multi-Language Electronic Menu System

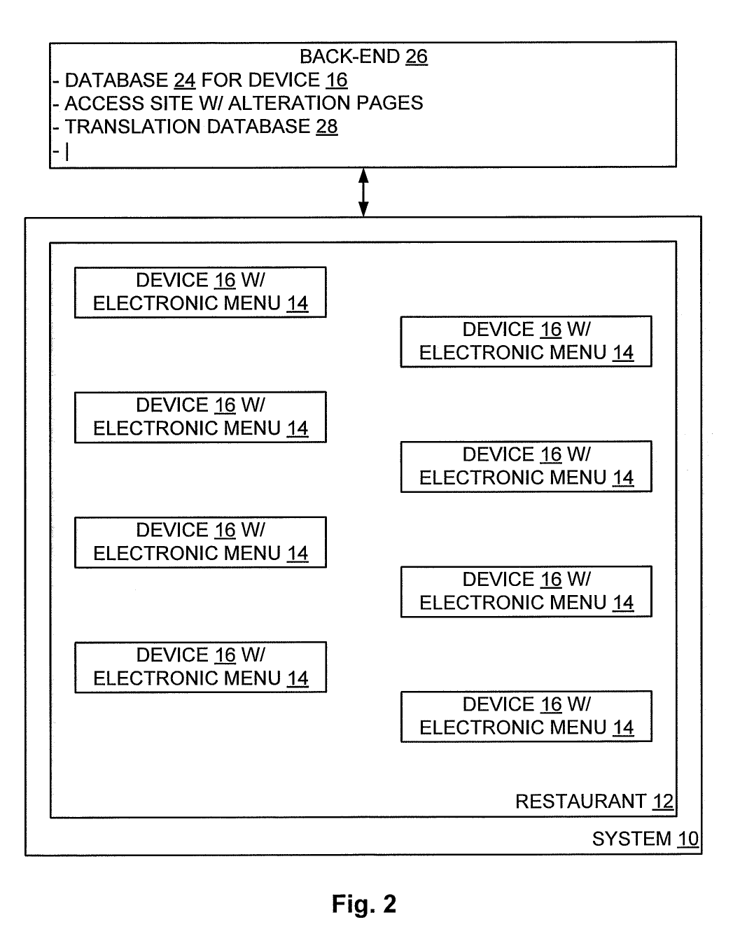

Turning now to FIG. 2, the system herein will now be illustrated with reference to a restaurant having a restaurant menu for ordering food or other gift or merchandise items, with a fulfillment area that is a restaurant kitchen. While this is used for illustration, it should be understood that a readily analogous system may be set up for ordering items or services at other locations such as hotels, sports and entertainment arenas, travel terminals, airplanes, and the like as noted elsewhere herein in further detail. In FIG. 2, it is seen that a system 10 is provided for a restaurant 12 or other establishment as provided above to provide an electronic menu 14 or the like to a user such as a patron. In one embodiment, the electronic menu 14 is provided as one or more applications instantiated on an electronic data processing device 16, such as for example a portable touch-screen device, a portable computer, a portable data assistant, or the like. For example, the device 16 may be an iPod Touch computing device or an iPad computing device, both products of Apple Corporation of Cupertino, Calif., or may be a Samsung Galaxy computing device, a product of Samsung Corporation of Seoul, South Korea, or a Blackberry hand-held computing device, a product of RIM Corporation of Waterloo, Ontario, among others. Alternately, the device 16 may be non-portable, either based on size or being fixedly attached to a non-portable structure.

As may be appreciated and as seen in FIG. 2, the restaurant 12 may be equipped with multiple devices 16, each having an electronic menu 14 instantiated thereon, and a wait-person or the like at the restaurant 12 would hand out a device 16 to each party patronizing the restaurant 12 or even to each individual patron, rather than handing out one or more pre-printed menus. Alternately, the device 16 may for example be fixedly attached to or embedded within a table or the like at which the party is seated, in which case the device 26 need not be handed out but instead is already available to the party. Such devices 16 may be pre-programmed according to known electronic ordering software to coordinate a specific device with a given wait-person and/or table or other location in the restaurant with an identifier that may be programmed to edited to coordinate with a specific user in a manner known in the art or using any technique to be developed.

As with most any menu, the electronic menu 14 on each device 16 includes a number of food items 18 that may be ordered and consumed at the restaurant 12. As was previously pointed out, each food item 18 of the menu 14 may be a typical menu food item, such as a glass of orange juice, a side of French fries, a platter with a hamburger, onion rings, lettuce, tomato slice, and pickle, and the like. Each food item 18 of the menu 14 would typically be included within a category (Sandwiches, Soup, Entrees, Drinks, etc.), would have a name (The Kowabunga Burger, Turkey Special, Home-made Iced Tea, etc.), and have a specified price, and such menu food item 18 may also include accompanying information such as a description and/or a picture of the food item 18. It is to be noted that the menu may be arranged so that the general categories are on a first menu screen, and then the patron can go to an individual page where further detailed information for an item within the category may be found, including details such as price, ingredients, and other information. Patrons will also be able to specify choices for that item or other information that can be selected and/or deselected depending on a patron's preference (e.g., whether an item is desired to be served hot or cold, whether meat is rare, medium or well, whether a burger includes or does not include condiments, size of a restaurant T-shirt gift item, selected merchandise, etc.).

As before, each patron may peruse the food items 18 in the electronic menu 14 and select one or more food items 18 for consumption at the restaurant 12. In various embodiments, though, the patron orders the selected food items 18 by selecting same directly from the menu 14 on the device 16 so as to build an electronic order on the device 16. Once the electronic order has been completed for a patron or a party, then, the electronic order may be electronically submitted, either directly from the device 16 to a kitchen of the restaurant 12, or indirectly by handing the device 16 with the electronic order back to the wait-person.

It is possible that a user such as a patron may open an order, go through the menu and decide not to order a food item, in which case, the order may be terminated, but translations for review of the menu would still be available as described further herein, even if a final order is not submitted for a food item.

As may be appreciated, when the order is electronically submitted directly from the device, the electronic order may perhaps be sent electronically from the device 16 to the kitchen, perhaps by a wireless local connection (‘Wi-Fi’) or a cellular telephone system connection, to the restaurant's order entry and retrieval system or any other similar order retrieving system being used by and/or associated with the kitchen. It may even be the case that the order is sent to the kitchen by way of a back-end server such as the back-end 26 set forth in more detail below. In the latter case, the electronic order may perhaps be sent electronically from the device 16 to the kitchen by walking the device 16 to and physically connecting the device 16 to such an order entry and retrieval system. Alternately, the order may first be converted into a paper form before reaching the kitchen. Notably, the aforementioned order entry and retrieval system may be disposed with, in which case the device 16 with the electronic order may be reviewed directly by staff in the kitchen. In any event, with the electronic order in hand, the kitchen prepares the food items 18 thereof, the wait-person delivers the prepared order to the patron or party, and the patron or party then consumes the food items 18 in the prepared order.

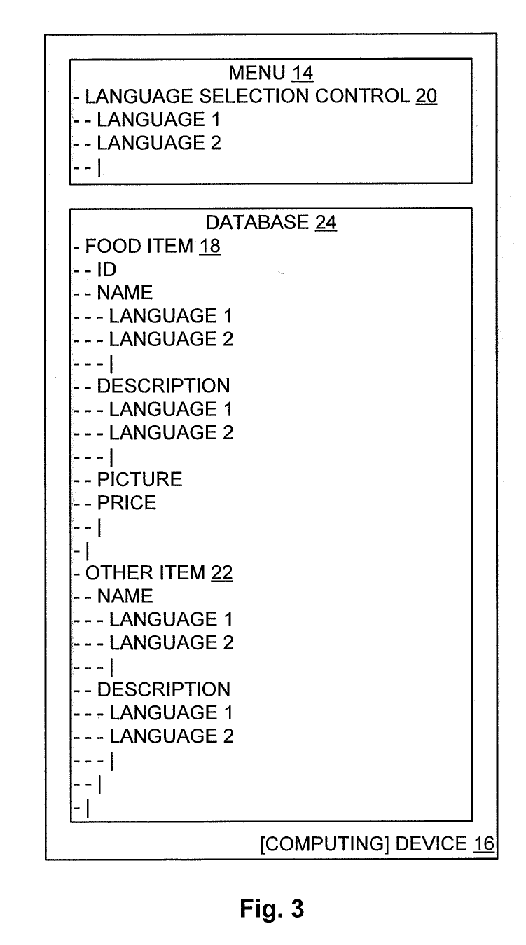

As was set forth above, a restaurant 12 may find it advisable to have the electronic menu 14 thereof available in multiple languages. For example, the restaurant 12 may normally operate based on the English language, but may also wish to accommodate patrons/parties (hereinafter, ‘patrons’) that are fluent in the German, French, and/or Spanish languages, among others. Thus, in various embodiments, and turning now to FIG. 3, the electronic menu 14 on each device 16 includes a language selection control 20 by which a patron may select from among multiple available languages. Correspondingly, in various embodiments, each food item 18 in the menu 14 includes descriptive language in each of the multiple available languages. Thus, a particular food item 18 would, for each of the multiple available languages, have a name in the language and perhaps a description in the language, presuming that the food item 18 has an accompanying description.

Note here that in addition to each food item 18, other items 22 in the menu 14 would, for each of the multiple available languages, have a name in the language and perhaps a description in the language, presuming that the other item has an accompanying description. As may be appreciated, such other items 22 in the menu 14 may include the various and sundry information that would normally be included in the menu 14, including perhaps the aforementioned food categories, a name of the restaurant 12, an address of the restaurant 12, a description of the restaurant 12, a description of local areas of interest, names associated with actuation buttons in the menu 14, etc.

Note too that the language-dependent data needed for each language for each food item 18 (the name, the description, etc.) or other item 22 and also the language-independent data for each food item 18 (the price, a picture, etc.) or other item 22 may be stored in any appropriate manner as long as the data is available if and when needed at the device 16. Thus, the data may be stored in a database 24 on the device 16, as is shown in FIG. 3, or may be stored locally with respect to the device 16, such as for example on a server in a local area network in the restaurant. The data may even be stored remotely with respect to the device 16, such as for example on a central server, again presuming that the data is available if and when needed at the device 16. Likewise, the data may be stored in any appropriate format, such as for example a relational database, one or more tables, or the like.

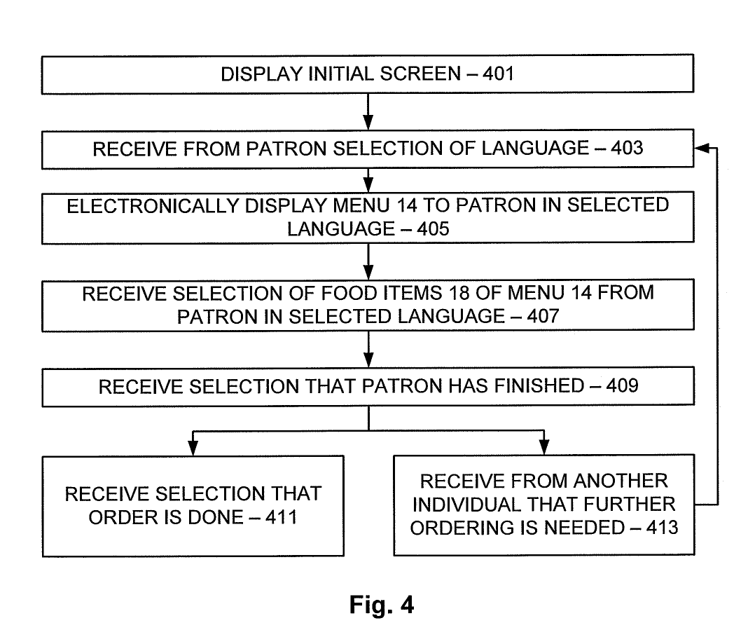

Turning now to FIG. 4, ordering of food items 18 by way of the menu 14 on the device 16 may be performed in a manner such as that which follows. Presumptively a patron is handed the device 16 by a wait-person or the like at a restaurant 12 or the like, and the device 16 has been set in an initial mode where an initial screen of information is displayed to the patron (401, FIG. 4). The initial screen may be any appropriate initial screen, and may be akin to the front of a printed menu or another initial display of information, along with an invitation for the patron to begin entering an order, perhaps by touching the screen of the device 16 if in fact the device 16 includes a touch-sensitive input-receiving screen.

Notably, upon the patron touching the screen or the like, the device 16 displays to the patron the language selection control 20 and receives from the patron a selection of a language to be employed in displaying food items 18 and other items 22 of the menu 14 to the patron (403). As will be set forth in more detail below, the languages available by way of the language selection control 20 for the menu 14 on the device 16 have been predetermined by the management of the restaurant 12 or the like, and the corresponding data required for each predetermined language for each food item 18 and other item 22 of the menu 14 has already been obtained. The language selection toggle for choosing language can be available to patrons for use at all times for users to display the menu 14 in different languages at will.

After the patron selecting the language, the device 16 then electronically displays the menu 14 to the patron in the selected language (405). As may be appreciated, electronically displaying such menu 14 may be performed in any appropriate manner. For example, it may be that the food items 18 of the menu 14 are categorized, in which case the device 14 may initially display the available categories of food items 18 to the patron in the selected language. In such case, the patron would then touch upon one of the displayed categories on the device 16 to select and view the food items 18 in such category according to the selected language. As may be appreciated, to select and order a particular food item 18, the patron may touch corresponding text and/or a corresponding image as it appears on the screen of the device 16, or may touch an ‘order’ control adjacent the displayed food item 18 on the screen of the device 16, among other things. In either case, touching the displayed food item 18 itself may cause additional information relating to same to be displayed, such as for example a picture of the food item 18, an additional description of the food item 18, or the like. In this instance, the patron will also be able to select or deselect various item-specific options if provided, such as how a patrons meat is cooked (rare, medium or well), whether they do or do not want certain items on a sandwich, whether the food is served hot or cold, what size a drink is, etc.

Similarly, if items other than food items are available by menu, such as gift or merchandise items including clothing, other options or additional description can be provided for selection or deselection, like T-shirt size, personalization for gift items, colors, etc. The menu selection can also be arranged to prompt pre-prepared or pre-suggested menu combinations built into the selection process. For example, for restaurants that pair a wine and dessert with a meal as a suggestion or are creating a series of “price fixe” menu selections, choosing one item or a “collection of items” will prompt other questions. For example, if someone chooses a steak, the menu can provide a choice asking the patron if it would like to choose a suggested red wine or side dish. If the patron chooses “price fixe” options, a menu prompt may ask the patron if he or she would like options within a collection of pre-designated appetizers, entrees, desserts and beverages for a specific group price. Other variations of these types of options are also envisioned as within the scope of the invention.

In various embodiments, the menu 14 on the device 16 is hierarchically organized and displayed to the patron. Accordingly, the patron ‘drills down’ into successive layers to review food items 18 and additional information related thereto, and also employs return controls or the like to return to previous layers. Note though that while such hierarchical organization is believed to be beneficial, such hierarchical organization is not required in all circumstances. In particular, it might be the case that ordering a food item 18 automatically returns the patron to the display of categories in the selected language, along with an invitation in the selected language to order another food item 18. At any rate, the patron may generally be expected to navigate amongst the categories and food items 18 of the electronic menu 14 on the device 16 and in doing so the device 16 receives selections of one or more of the food items 18 of the menu 14 to be ordered for such patron, all in the selected language (407).

Note that in at least some instance, ordering a food item 18 requires collecting additional information from the patron regarding the ordered food item 18, all according to the selected language. As one example, it may be that ordering a steak requires receiving a selection in the selected language from the patron of the degree to which the steak is to be cooked (rare, medium, well, etc.) along with a selection in the selected language from the patron of the type of cooking to be performed (broiled, seared, etc.). As another example, it may be that ordering a platter requires receiving a selection in the selected language from the patron of sides to be included with the platter (soup or salad, baked potato or mashed potato, etc.) along with a selection in the selected language from the patron from among a number of available sides (broccoli, carrots, peas, etc.). In any case, the format of the menu 14 as well as the additional information needed for each ordered food item 18 has been predetermined by the management of the restaurant 12 or the like, and the menu 14 has been constructed by or for such management in a manner that will be set forth in more detail below.

At some point, the patron has finished ordering food items 18 or has elected not to order items. Accordingly the device 16 receives a selection from the patron that the patron has so finished (409). Notably, it may be that the patron is a single individual and thus is the only person ordering food items 18 by way of the device 16, or that the patron is one of a group of individuals in which case it may be that another one of the individuals is to order food items 18 by way of the device 16. In the former case, the device 16 may receive from the single individual a selection that the order is done (411). In the latter case, the device 16 may receive from the first user or a second other user in the group that further ordering is needed (413). As may be appreciated, if further ordering is needed, the second other user proceeds to order in a manner akin to that which occurred before. In particular, in various embodiments, the another individual may select a language as at 403 and then proceed to the actions of 405 et seq., or may elect to continue with the language already selected and proceed directly to the actions of 405 et seq.

As should be appreciated, once all individuals in a group review the menu 14 on the device 16 and enter an order thereinto, the device does indeed receive a selection that the order is done as at 411. If nothing was added to the order (i.e., no items were selected by any user), then the device receives a selection that the order is done, but the order would just be empty or void so as to clear/open a new order for the next user or group of users.

Once a selection is received that the order is done 411, the device 16 now has compiled an order for an individual or group of individuals, and it items were requested by one or more of the users, the order comprises a number of food items 18 for the individual/group. Note here that with regard to a group of individuals, the device 16 in the course of compiling the order may track the order for the overall group without regard for what food items 18 each individual in the group selects, or may track the order specifically with regard to what food item 18 each individual in the group selects.

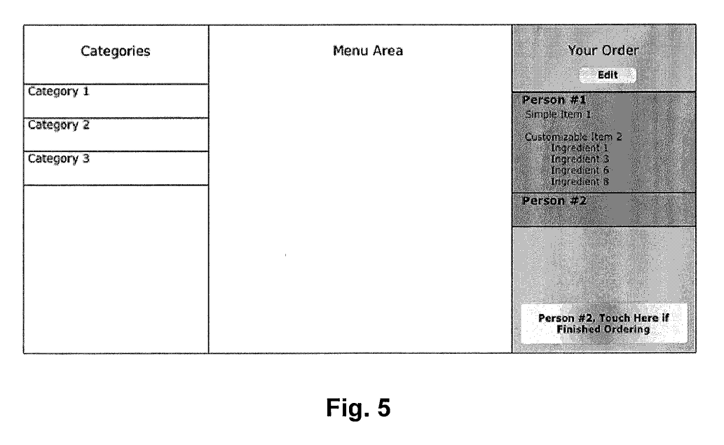

As seen in FIG. 5, one example of a screen of a device 16 is shown. As shown, the screen of the device 16 is large enough so that a category area, a menu area, and an order summary area can be simultaneously displayed. As may be appreciated, the category areas shows multiple selectable categories of food items 18, and the menu area may show food items 18 from a selected category, while the order summary area shows food items 18 that have been selected for an order. Note, though that in various embodiments, such areas may be individually displayed, particularly if the screen of the device 16 is smaller. At any rate, as seen, the device 16 is compiling an order for at least two people and is in fact tracking the order specifically with regard to what food item 18 each individual in the group selects. As also seen, the food items 18 may include a ‘simple’ item for which no further customization is required, as well as a ‘customizable’ item which includes such further customization.

Notably, the order as compiled by the device 16 may be stored in the device 16 according to an ID (in the database 24 of FIG. 3) for each food item 18 in the order, and need not be stored according to the name of the food item 18 in any particular language. Thus, after the order is done as at 411, the order may be sent to the kitchen or the like of the restaurant 12 or the like in a format independent of any particular language (415). Note here that such sending may be performed in any of various manners. For example, the device 16 may electronically deliver the order by way of a wireless local or wide area network, or the wait-person may physically walk the device 16 to the kitchen or other location and then electronically couple the device to an order entry system or the like, give the device 16 to personnel in the kitchen for direct viewing, or connect to or simply use a central tablet including all orders from all tablets.

In any case, if the order is stored in the device 16 according to the ID for each food item 18 therein, personnel at the kitchen may retrieve the order from the device 16 in any of the languages supported by the device 16, or even other languages if supported externally from the device (417). In particular, and as may now be appreciated, for each food item 18 in the order, the ID thereof and a selection of a language may be employed to index into the data in the device 16 (FIG. 3) or elsewhere to find the name of the food item 18 in the selected language. Thereafter, such personnel in the kitchen may prepare the order for delivery to and consumption by the ordering individual or group of individuals.

The data in the device 16 for the menu 14 may be collected and placed on the device 16 in any appropriate manner. For example, the data may be manually added, deleted, and altered (hereinafter, ‘altered’) on each device 16 in the restaurant 12 or the like, or may be manually added and altered at a local server at the restaurant 12 or the like and then directly downloaded to each device 16. Note, though, that it may be advantageous to automate the altering of the data, and also to perform the altering of the data without requiring any additional hardware or software at the restaurant 12 or the like.

Accordingly, in various embodiments, such altering of such data may be performed directly on one of the devices 16 at the restaurant 12 or the like, and then propagated to the other devices 16 at the restaurant 12 or the like. Note, though, that such altering can be performed by way of another computing device if available. Moreover, in various embodiments, the restaurant 12 or the like need not have any local back-end server or the like to manage the system 10 with the devices 16. Instead, in various embodiments, a centralized back-end server 26 (‘back-end 26’) is provided (FIG. 2), where the back-end 26 is remotely located and accessible from the restaurant 12 or the like by way of an inter-connected communications network such as the Internet, a wired or wireless communications network, a combination thereof, and/or the like. Thus, the back-end 26 can be employed by multiple restaurants 12 or the like and the cost of use for each such restaurant 12 or the like can be kept to a reasonable if not economical amount.

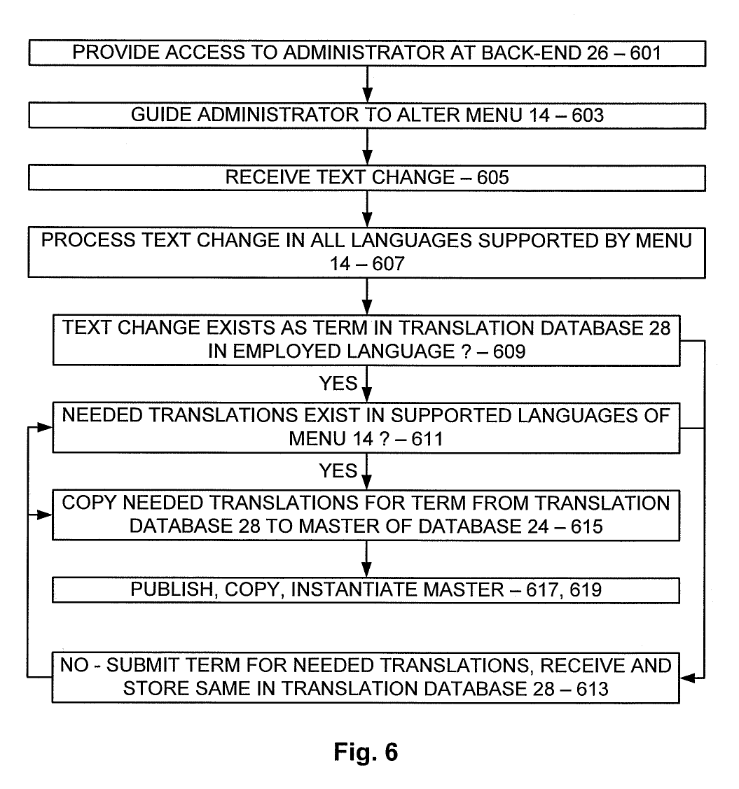

Presumptively, one or more personnel at the restaurant 12 or the like is granted administrative privileges to alter the data for the menus 14 on the devices 16. In various embodiments, then, and turning now to FIG. 6, such an administrator would employ one of the devices 16 or another computing device to gain access to the back-end 26 (601), perhaps by way of a back-end access application or a back-end access site and an appropriate user name and password which identifies the administrator and also the restaurant 12. Upon being granted access at the back-end 26, then, the administrator may be guided by the back-end 26 through various pages or the like that collectively allow the administrator to alter the menu 14 thereof on each of the devices 16 at the restaurant 12 or the like (603).

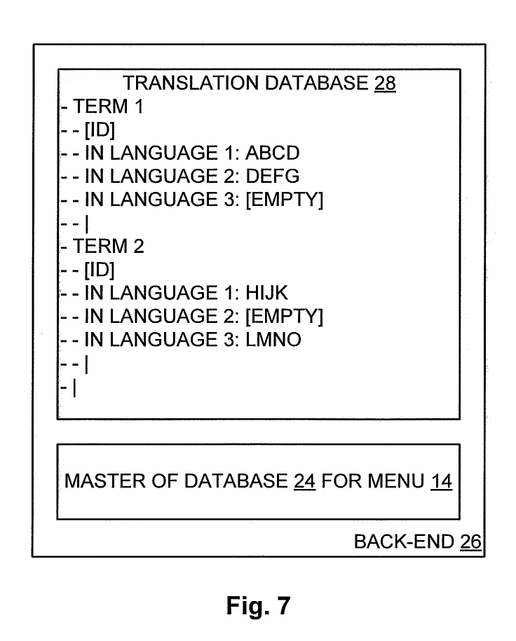

Thus, the administrator would be able to add, remove, and otherwise alter categories and food items 18 in the menu 14, and for example may change names and prices, add or remove pictures of food items 18, change other items 22, add or remove available languages, and the like, among other things. Notably, and in various embodiments, each time the back-end 26 receives added or changed descriptive text (hereinafter, a ‘text change’) (605), the back-end 26 processes the text change so that the text change occurs in all languages supported by the menu 14 of the restaurant 12 or the like (607). In connection therewith, and as seen in FIGS. 2 and 7, the back-end may in various embodiments maintain a translation database 28 which is employed to store known translations for terms.

Turning now to FIG. 7, it is seen that the translation database 28 may in various embodiments include for each of several terms an entry with a translation of the term into each of at least some languages supported by the back-end 26. Initially, the translation database 28 may be expected to be sparsely populated with translation data or perhaps pre-populated based on commercially obtained translation data. Thus, it is expected that entries in the translation database 28 may be at least partially empty, as is shown, and that over time the translation database 28 will fill with translation data as such data is requested and obtained, perhaps in a manner such as that which is set forth in more detail below. As may be appreciated, the translation database 28 may be organized in any appropriate manner. For example, and as seen in FIG. 7, it may be that the translation database 28 is organized according to each term therein, and includes for each term an ID or the like and a representation of the term in at least some of the languages supported by the back-end 26. As should be understood, the translation database 28 may have the form of a relational database, an XML (eXtensible Markup Language) database, a table, or another appropriate form.

Note here that a term as stored in the translation database 28 may be a word, a phrase, or perhaps even a clause, a sentence or a paragraph if need be. Thus, the term may for example be ‘hamburger’, ‘chicken salad with fries’, ‘chicken-fried steak’, ‘a thick porterhouse steak with your choice of two side dishes, soup, a salad, and your choice of dessert’, or the like. As may be appreciated, though, a shorter term is more likely to be needed in multiple menus 14 for multiple restaurants 12, while a longer term is less likely to be needed in multiple menus 14 for multiple restaurants 12.

In various embodiments, the back-end 26 processes a text change as at 607 by: determining from the translation database 28 whether the text change exists as a term in an entry in such translation database 28 in the language which the administrator of the restaurant 12 is employing (609), and if so whether the entry for the term has needed translations in the languages which the menu 14 of the restaurant 12 is expected to support (611). If the text change does not exist as a term in an entry, then the back-end 26 submits the term for the needed translations and receives and stores same in the translation database 28 (613). If the text change exists as a term in an entry and if the entry for the term has some but not all of the needed translations, then the back-end 26 likewise submits the term for the needed translations and receives and stores same in the translation database 28 as at 613. As may be appreciated, each needed translation may be obtained by the back-end 26 in any appropriate manner. For example, the back-end 26 may electronically refer to an on-line database for each translation, or may electronically send a message to a translator for each translation and electronically receive the translation in reply, or may electronically send a message to an operator for each translation, after which the operator obtains the translation in an appropriate manner and manually supplies same, and/or the like.

Once all needed translations for a term are present in the translation database 28, the needed translations for the term may then be appropriately copied from the translation database 28 to a master of the database 24 associated with the menu 14 (615), where the master of the database 24 is maintained at the back-end 26, as is seen in FIG. 7. For example, such appropriate copying may include copying only those translations of a term needed for the master, and may include formatting the translations into the format required by the master, among other things. As should be appreciated, if the text change exists as a term in an entry and if the entry for the term already has all of the needed translations, then the needed translations for the term may be copied forthwith from the translation database 28 to the master of the database 24 associated with the menu 14, as at 615.

Once the back-end 26 has operated to make all text changes by appropriately altering the master of the database 24, such master may then be published or the like (617), and the published master may then be copied to and instantiated on each device 16 at the restaurant 12 (619). As should be understood, such publishing, copying, and instantiating may be performed in any appropriate manner. For example, the copying and instantiating may include the back-end 26 pushing the published master to each device 16 for instantiating thereon in an appropriate manner, or may include directing each device 16 to pull the master from the back-end 26 and instantiate same thereon in an appropriate manner. In either case, an appropriate electronic communications link may be established between each device 16 and the back-end 26, perhaps by a hard-wire connection or by a wireless local and/or wide area network connection.

As an alternative to the copying as at 615, it may instead be the case that the master of the database 24 includes a pointer or reference to the translation database 28 for the needed translations for each term. In such a case, and as should be appreciated, changes in the translation database 28 are automatically propagated to and reflected in the master of the database 24. Thus, publishing as at 617 to produce the published master would include employing each reference in the master of the database 24 to obtain the needed translations for the corresponding term from the translation database 28, which presumably would be as complete as possible.

Note that the back-end 26 may require a relatively lengthy period of time to make all text changes by altering the master of the database 24, perhaps on the order of a few minutes to as much as 72 hours or more. If so, and in an effort to produce something relatively quickly, it may be that the master is published or the like as at 617 but without all needed translations and then is copied and instantiated as at 619. If so, the back-end 26 may update the master as needed translations are received and publish and send out interim versions of the master and/or the final version of the master.

An example of the back-end 26 processing a text change is instructive. Presume that the translation 28 database includes the following entry, which is presented in a pseudo-code having an XML-type format:

<entry>

<id>1134</id>
<title>

<translations>

<translation>

<locale>en_US</locale>
<text>apple pie</text>

</translation>
<translation>

<locale>es_ES</locale>
<text>pastel de manzana</text>

</translation>
<translation>

<locale>de_DE</locale>
<text>apfelkuchen</text>

</translation>
<translation>

<locale>fr_FR</locale>
<text> </text>

</translation>

</translations>

</title>

</entry>

As seen, the entry includes English, Spanish, and German versions of the term ‘apple pie’, but does not likewise include a French version, which in this case would be ‘tarte aux pomme’. As also seen, the entry includes for each version of the term a ‘locale’ attribute that identifies both the language of the version (en in en_US being English, for example) and also a geographic location where the version is intended to be employed (US in en_US being United States, for example). As may be appreciated, such a locale attribute may be employed in a context where a term has differing versions of the same language depending on geographic location, or where a geographic location can have multiple differing versions of languages. Now further presume that an administrator at a restaurant 12 or the like wishes to include the term ‘apple pie’ in a menu 14 for the restaurant 12 or the like, where the menu 14 is expected to include English, Spanish, and French support.

Here, ‘apple pie’ exists as a term in an entry in the translation database 28 in English, as at 609, and the entry for the term has needed translations in some but not all of the languages which the menu 14 of the restaurant 12 is expected to support. Accordingly, the back-end 26 may be expected to submit the term ‘apple pie’ for the needed French translation, after which the back-end 26 receives and stores same in the translation database 28 as at 613:

<entry>

<id>1134</id>
<title>

<translations>

<translation>

<locale>en_US</locale>
<text>apple pie</text>

</translation>
<translation>

<locale>es_ES</locale>
<text>pastel de manzana</text>

</translation>
<translation>

<locale>de_DE</locale>
<text>apfelkuchen</text>

</translation>
<translation>

<locale>fr_FR</locale>
<text>tarte aux pomme</text>

</translation>

</translations>

</title>

</entry>

Thereafter, the needed translations for the term ‘apple pie’ may then be appropriately copied from the translation database 28 to the published master of the database 24 associated with the menu 14 as at 615 and 617:

Entry 1134:

English (US): apple pie;

Spanish (Spain): pastel de manzana;

French (France): tarte aux pomme.

Here, the entry as present in the master does not include the German translation inasmuch as the menu 14 is expected to include English, Spanish, and French support and not German support. Alternately, the German translation may be included as a matter of ease, even if not supported by the menu 14. Note too that in the present example, the entry in the master has been translated by the back-end 26 into a different pseudo-code, perhaps also as a matter of ease, formatting, or economy of space.

As set forth herein, altering the menu 14 in pertinent part includes the back-end 26 receiving and operating on text changes to the menu 14, including text changes to the food items 18 and other items 22. Note, though, that the altering may also include the back-end 26 receiving and operating on non-text changes, including changes to layout, pricing, categorization, styling, customizations, etc. Such non-text changes may be effectuated in any appropriate manner and therefore details of such non-text changes are not set forth herein in any detail. Examples of non-text changes or information to be included in the back-end are voice or video files explaining the item or providing background that are linked to the item's ID and accessible by a user through the device. For example a sound file pronouncing the item in the selected language or explaining the item in the selected item can be selected by a user on the screen interface and the voice file recalled from the back-end to play back for the user.

Other ID-linked items accessible from the back-end or another source linked to the back-end may include, for example, translated nutrition information for a given item which may be provided in a text or other file. If a particular device is associated with a wait-person or similar personnel, a “pinging” or paging function, as is also known in the art of point of service ordering can be integrated into the devices so that after an order is complete, the user can ping the wait-person to let them know to come back to the table or to page the wait-person for other services.

Other non-linked items may be stored as well for the entertainment of the user of the device while the user waits for items or in advance of ordering, for example, games, trivia, restaurant surveys, access to social media which may or may not be integrated with items in the backend using APIs of developers such as Facebook®, Twitter®, Foursquare®, Yelp®, etc. Restaurant information (links to establishment websites) and other background information can also be made accessible directly on the ordering screen, by touch button or link, for example, address, phone number, website, maps, directions, etc.

In the case of games, internet surfing, trivia and the like a link or touch button can be made available to the user to access from the device either through an integrated weblink or through the back-end server. Alternatively, social media sites may operate similarly or through a more integrated and/or ID-linked manner. For example, for a given food item, if the user likes the food, he or she can comment on Facebook® or a similar site their information through the website using the handheld or incorporate links back to the electronic menu for recall comments for later users of the menu. So, if a user likes something he or she ordered, comments can be stored linked to the ID on the back-end for recall with a touch button (“see comments” or the like) near the item so the user can read others' opinions of the item. The item may be separately ranked or commented on a person's personal Facebook® page as well. Such linking and integration are known in the art and any technique known to a programmer of skill in the art or to be developed may be used to provide such integration or Internet linkage.

It is also possible to link the order once complete to an electronic payment service depending on the request of the establishment (e.g., if they are a user of Paypal® or Square®. This can enable users to pay through an alternative path if desired as opposed to traditional swiping, cash, etc. Such services and connections to such services are also well known in the art and so are not separately described herein and may be added by any known method of providing such services through a web or back-end server connection as is known in the art or to be developed.

It is desirable also to add to the system, phone or other PDA, iPad, tablet or other devices, applications or links that allow the users of such devices to be informed as to which establishments in a given location use the present dynamic translation tool in their menu services. Thus before traveling, or when in a new area, a user can first access through their Droid®, iPhone® or the like, an application which tells them that there are X number of restaurants, for example, within a given distance of the person's location (either entered or through GPS) that use the tool to enable the user to visit translation-friendly establishments.

The back-end server can also be configured so as to collect food ordering information and save such orders for analytical user by the establishment owner, for example, to work with inventory tracking, customer type, purchase type, numbers of times a given food is ordered, liked/disliked, etc. Such data analysis and manipulation would be customized using known data analytical techniques and algorithms known in the art.

The programming believed necessary to effectuate the processes performed in connection with the various embodiments of the present innovation is relatively straight-forward and should be apparent to the relevant programming public. Accordingly, such programming is not attached hereto. Any particular programming, then, may be employed to effectuate the various embodiments of the present innovation without departing from the spirit and scope thereof.

In the present disclosure, a system and a method are provided that allow a restaurant 12 or the like to provide a multi-language menu 14 or the like to a patron or the like, and that allow the restaurant 12 to receive an order from the patron in one language and to review and fulfill the order in another or the same language. The multi-language menu 14 is on an electronic device 16 that allows the patron to select from among multiple languages to peruse the menu 14, that collects the order from the patron in the selected language, and that provides a translation of the order into another or the same language for fulfillment. A centralized back-end helps the restaurant 12 to construct and update the electronic multi-language menu 14.

It should be appreciated that changes could be made to the embodiments described above without departing from the innovative concepts thereof. For example, although the present innovation is set forth primarily in terms of an electronic menu 14 for a restaurant 12, any other entity with any other option-selection needs may also benefit from such system and method. Similarly, any other arrangement of back-end 26 and communications employed by each device 16, among others, may be employed. It should be understood, therefore, that the present innovation is not limited to the particular embodiments disclosed, but is intended to cover modifications within the spirit and scope of the present innovation as defined by the appended claims.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A method of operating a multi-language electronic menu on a computing device having memory within which the menu is instantiated, a processor for operating the instantiated menu in the memory, a screen for displaying a visual interface to the menu, and a selection device for selecting menu options displayed on the screen, the method comprising the device:
displaying to a user a language selection control and receiving from the user by way of the displayed language selection control a selection of a language to be employed in displaying menu items to the user, the language being selected from among a number of predetermined available languages;
electronically displaying the menu to the user in the selected language;
allowing the user to navigate amongst the menu items of the menu on the device and receive selections of one or more of the items of the menu to be ordered or requested for such user in the selected language;
receiving a selection from the user that the user has finished selecting menu items;
receiving a selection that an order comprising at least one selected menu item of responding to at least one request for the user is complete; and
sending the order or request from the device for fulfillment in a format independent of any particular language.

2. The method of claim 1, wherein the computing device sends the order or request electronically from the device to a fulfillment area by one of a wireless local connection and a cellular telephone system connection.

3. The method of claim 2, wherein the menu is a restaurant menu and the user is a patron who is a customer ordering menu items that are food items at a restaurant and the fulfillment area is a restaurant kitchen.

4. The method of claim 1, wherein the menu is a restaurant menu and the user is a patron who is a customer ordering menu items that are food items at a restaurant.

5. The method of claim 1, wherein the menu is a menu for ordering food or other items at a location selected from restaurants, hotels, cruise ships, aircraft, sports or entertainment arenas, and travel terminals.

6. The method of claim 1, wherein electronically displaying the menu to the user in the selected language includes displaying menu items in the selected language according to predetermined categories, the predetermined categories being displayed in the selected language.

7. The method of claim 1, wherein the screen of the device is a touch-sensitive screen incorporating the selection device and wherein the user selects by touching the touch-sensitive screen at a corresponding area thereof.

8. The method of claim 1, wherein the menu is hierarchically organized and displayed to the user.

9. The method of claim 1, wherein receiving a selection of a menu item of the menu further comprises collecting additional information from the user regarding the ordered menu item, all according to the selected language.

10. The method of claim 1, wherein the user is a first patron, and the method further comprises:
receiving from the first patron or a second patron a selection that further ordering is required;
displaying to the second patron the language selection control and receiving from the second patron by way of the displayed language selection control a selection of a second language to be employed in displaying menu items to the second patron, the second language being selected from among a number of predetermined available languages, wherein the first language is the same or different from the second language;
electronically displaying the menu to the second patron in the selected second language;
allowing the second patron to navigate amongst the menu items of the menu on the device and in doing so receiving selections of one or more of the items of the menu to be ordered or requested for such second patron, all in the selected second language;
receiving a selection from the second patron that the second patron has finished selecting menu items; and
receiving a selection that an order or request comprising at least one selected item for each of the first and the second patrons is complete.

11. The method of claim 1, wherein the user is a first patron, and the method further comprises:
receiving from the first patron or a second patron a selection that further ordering is required;
displaying to the second patron the language selection control and receiving from the second patron by way of the displayed language selection control a selection of a second language to be employed in displaying menu items to the second patron, the second language being selected from among a number of predetermined available languages, wherein the first language is the same or different from the second language, or receiving from the second patron a selection to continue in the first language;
electronically displaying the menu to the second patron in the selected second language;
allowing the second patron to navigate amongst the menu items of the menu on the device in the selected second language;
receiving a selection from the second patron that the second patron has finished selecting menu items and that the order is complete, or that the order is complete without an additional item from the second patron.

12. The method of claim 1, wherein the order is stored in the device according to an ID for each menu item in the order, and not according to any particular language.

13. The method of claim 1, wherein the order is stored in the device according to an ID for each menu item in the order, and not according to any particular language, each menu item of the menu being stored in the memory of the device in a database, the database including for each menu item the ID thereof and a translation of the menu item in each of the predetermined available languages.

14. A method of altering a multi-language electronic menu on each of a plurality of computing devices at an entity, the method being performed at a back-end server having access to the plurality of devices and the method comprising the back-end server:
granting access to an administrator of the devices for the entity;
guiding the administrator through altering the menu on each of the devices, and in doing so receiving a text change to text of a menu item; and
processing the text change so that the text change occurs in each of a number of predetermined languages supported by the menu, the text change being processed with reference to a translation database which is employed to store known translations for terms in multiple languages.

15. The method of claim 14, wherein the back-end server is remotely located from the administrator, the back-end server servicing other administrators at other entities, each of the other entities also having a multi-language electronic menu on each of a plurality of computing devices at each of the other entities.

16. The method of claim 14, wherein the translation database includes for each of several terms an entry with a translation of the term in at least one language supported by the back-end server.

17. The method of claim 14, wherein the translation database includes for each of several terms an entry with a translation of the term in at least one language supported by the back-end server, wherein the translation database is initially sparsely populated with translation data such that entries in the translation database are at least partially empty, and wherein over time the translation database is filled with translation data as such data is requested and obtained.

18. The method of claim 14, wherein the text change comprises a term in a particular language supported by the menu, the term being stored in the translation database in a corresponding entry having the term and translations of the term in each of at least some languages supported by the back-end server.

19. The method of claim 14, wherein the text change comprises a term in a particular language supported by the menu, the term being one of a word, a phrase, a clause, a sentence, or a paragraph.

20. The method of claim 14, wherein processing the text change comprises determining from the translation database whether the text change exists as a term in an entry in such translation database; and if so determining whether the entry for the term has needed translations in the predetermined languages supported by the menu.

21. The method of claim 14, wherein processing the text change comprises:
determining from the translation database that the text change exists as a term in an entry in such translation database; and that the entry for the term needs at least one translation in at least one of the predetermined languages supported by the menu;
submitting the term for the needed translation or translations and receiving and storing same in the translation database;
copying the translation for the term in at least one of the predetermined language supported by the menu from the translation database for which a translation was needed to a published master of the menu according to a master of a database associated with the menu, the master of the database being maintained at the back-end server; and
copying the published master from the back-end server to each device, the copied master for being instantiated as the menu database on each device, each menu item of the menu being stored in a memory of each device in the menu database, the menu database including for each menu item a translation of the menu item in each of the predetermined languages supported by the menu.

22. The method of claim 21, wherein submitting the term includes at least one of electronically referring to an on-line database for each needed translation, electronically sending a message to a translator for each needed translation and electronically receiving the needed translation in reply, and electronically sending a message to an operator for each needed translation, after which the operator obtains the needed translation and manually supplies same.

23. The method of claim 21, wherein the copying includes formatting the translation for the term into a format employed by the published master.

24. A computing system employed to alter a multi-language electronic menu on each of a plurality of computing devices at an entity, the computing system having memory within which a back-end server is instantiated as a set of instructions, and a processor for operating the instantiated back-end server in the memory by executing the instructions, the computing system having access to the plurality of computing devices, wherein the instructions of the back-end server include instructions for:
granting access to an administrator of the devices for the entity;
guiding the administrator through altering the menu on each of the devices, and in doing so receiving a text change to text of a menu item; and
processing the text change so that the text change occurs in each of a number of predetermined languages supported by the menu, the text change being processed with reference to a translation database which is employed to store known translations for terms in multiple languages.
